(19) United States
(12) Patent Application Publication
(10) Pub. No.: US 2026/0167751 A1
(43) Pub. Date: Jun. 18, 2026

(54) 9,10-DIHYDRO-9-OXA-10-PHOSPHAPHENANTHRENE-10-OXIDE- GRAFTED POLYBUTADIENE AND METHODS OF MAKING AND USING THE SAME

(71) Applicant: 3M INNOVATIVE PROPERTIES COMPANY, St. Paul, MN (US)

(72) Inventors: Eumi Pyun, St. Paul, MN (US); Hae-Seung H. Lee, Woodbury, MN (US)

(21) Appl. No.: 18/711,996

(22) PCT Filed: Jan. 20, 2023
(86) PCT No.: PCT/IB2023/050510

§ 371 Date: May 21, 2024

Related U.S. Application Data
(60) Provisional application No. 63/306,537, filed on Feb. 4, 2022.

(51) Int. Cl. C08F 136/06; C08C 19/24

(52) U.S. Cl. CPC C08F 136/06; C08C 19/24

(57) ABSTRACT

Described herein is polymer comprising at least one interpolymerized monomeric: according to formula I: A method of making the polymer is described as well as use of the 9,10-dihydro-9-oxa-10-phosphaphenanthrene-10-oxide-grafted polybutadiene on a substrate to make a flame retardant article.

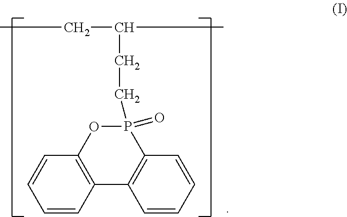

### TECHNICAL FIELD

Described herein a polybutadiene polymer grafted with DOPO (9,10-Dihydro-9-oxa-10-phosphaphenanthrene-10-oxide) and its method of making. Such compounds may be useful in the making of flame-retardant materials.

### SUMMARY

Polymers as a class of materials are generally flammable. Owing to their combustibility, thermoplastic and thermoset polymers, for example polyamides, polyesters, epoxy resins and polyurethanes, require the use of flame-retardants for many applications. Typically, halogenated compounds, more specifically, aromatic polybrominated compounds, have been commonly used as flame-retardant additives in polymers. However, halogenated flame-retardants have come under scrutiny because of ecological concerns. Thus, over the past couple decades, non-halogenated alternatives have been suggested.

One such replacement compound is DOPO (9,10-Dihydro-9-oxa-10-phosphaphenanthrene-10-oxide), which is a cyclic organophosphorous compound, known for its low toxicity, good thermal stability, and strong resistance to oxidation and hydrolysis. DOPO has been used as a fire retardant. Due to DOPO's crystallinity, poor ability to coat, and poor adhesion to substrates, DOPO is not commonly used by itself. Therefore, DOPO is used as an additive in another matrix. However, if the matrix comprises a polymer having a low glass transition temperature (for example, less than 100, 50, or even 25° C.), the DOPO can segregate and precipitate out over time.

Thus, there is a desire to identify new DOPO-derivatized compounds, which have advantages over other flame retardants.

In one aspect, a polymer is described, the polymer comprising at least one interpolymerized monomeric unit according to formula I:

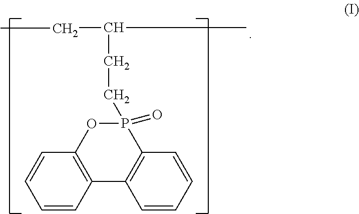

In one embodiment, the polymer further comprising at least one interpolymerized monomeric unit according to formula II

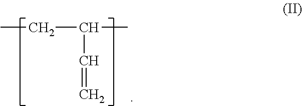

In one embodiment, the polymer further comprises at least one interpolymerized monomeric unit according to formula III

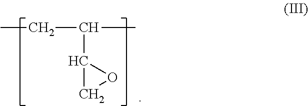

In another aspect, a composition is described. The composition comprises a polymer wherein the polymer comprises at least one interpolymerized monomeric unit according to formula

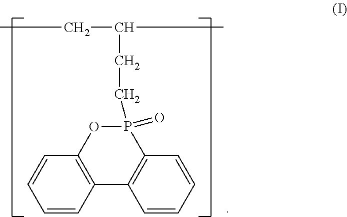

In yet another aspect, a multilayered article is described. The multilayered article comprises a substrate with a layer thereon, wherein the layer comprises a polymer wherein the polymer comprises at least one interpolymerized monomeric unit according to formula I

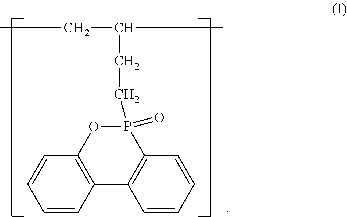

In a further aspect, a method making a polymer is described. The method comprising: contacting a polybutadiene polymer, and 9,10-dihydro-9-oxa-10-phosphaphenanthrene-10-oxide in a solvent to form a solution, wherein the polybutadiene polymer comprises at a plurality of pendent —CH═CH₂ groups;
contacting the solution with a radical initiator to form a pre-reaction mixture; and
initiating the radical initiator to generate radicals in the pre-reaction mixture to form the polymer.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term
“a”, “an”, and “the” are used interchangeably and mean one or more; and
“and/or” is used to indicate one or both stated cases may occur, for example A and/or B includes, (A and B) and (A or B);
“backbone” refers to the main continuous chain of the polymer;
“interpolymerized” refers to monomers that are polymerized together to form a polymer backbone; and
“monomer” is a molecule which can undergo polymerization which then form part of the essential structure of a polymer.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and a combination of all three.

In the present disclosure, it has been found that a DOPO-modified butadiene polymer can be used as a flame retardant.

### Polymer

The polymer of the present disclosure is a 9,10-dihydro-9-oxa-10-phosphaphenanthrene-10-oxide (DOPO)-grafted butadiene polymer, referred to herein interchangeably as the polymer of the present disclosure or as the DOPO-grafted polymer. Such a polymer is shown below, wherein at least one interpolymerized monomeric unit is according to formula I

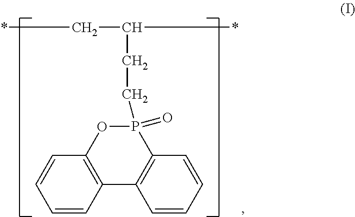

wherein the (*) indicates positions of connection where the interpolymerized unit is attached to other units and/or a terminal group. Terminal end group of polymers are known in the art.

In some embodiments, the polymer of the present disclosure comprises repeating interpolymerized monomeric units according to formula (II)

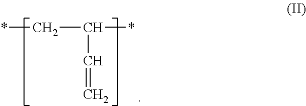

In some embodiments, the polymer of the present disclosure comprises repeating interpolymerized monomeric units according to formula (III)

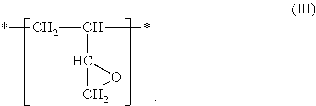

As will be discussed below, the polymer of the present disclosure is synthesized from a polybutadiene polymer predominantly comprising repeat units according to formula (II), however the polybutadiene polymer may comprise a minor amount (less than 15, 10, 5, or even 1%) of repeating units according to formula (IV)

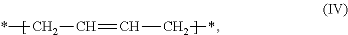

which may be in the cis or the trans configuration.

In one embodiment, a majority (greater than 50, 60, 70, 80, 90, or even 95%) of the repeating units in the polymer of the present disclosure are according to formula (I). Since the DOPO-moiety provides flame retardant capability, ideally as much DOPO as possible should be present in the grafted polymer. However, for a variety of reasons less DOPO-grafting may be present. For example, in one embodiment, more than 5, 10, 15, or even 20% of the repeating units in the polymer of the present disclosure are according to formula (I), but less than 50, 45, 40, 35, 30, or even 25%. Some reasons for the grafted polymer having less than a majority of repeating units according to formula (I) include: balancing the flame retardant properties with desired physical properties (e.g., flexibility), or whether the polymer of the present disclosure is used as the primary matrix in a coating or as an additive in another matrix.

In one embodiment, the polymer of the present disclosure is a copolymer comprising repeating units according to both formula (I) and formula (II). For example, a majority (greater than 50, 60, 70, 80, or even 90%) of the polymer of the present disclosure comprises repeating units according to formulas (I) and (II).

In one embodiment, the polymer of the present disclosure is a copolymer comprising repeating units according to both formula (I) and formula (III). In one embodiment, the polymer of the present disclosure comprises at least 5, 10, 15, 18 or even 20% and at most 45, 40, 35, 30, or even 25% of interpolymerized repeating units including to formula (III).

Typically, the copolymer of the present disclosure is a random copolymer.

In one embodiment, the polymer of the present disclosure comprises at least 0.1, 0.5, 1, 2, 5, 7, 8, or even 10% by weight phosphorous. In one embodiment, the polymer of the present disclosure comprises at most 10, 11, or even 12% by weight of phosphorous. An exemplary range of phosphorous in the polymer of the present disclosure is 7.2 to 12% or even 8 to 10.8%.

In one embodiment, the polymer of the present disclosure has a number average molecular weight of at least 1200, 1500, 1800, 2000, 2500, 3000, or even 3500 grams/mole. In one embodiment, the polymer of the present disclosure has a number average molecular weight of at most 12,000; 10,000; 8000; 6000, 5000, or even 4000 grams/mole. The molecular weight of the polymer may be determined using techniques known in the art such as gel permeation chromatography. Although, lower molecular weight polybutadiene polymers, which are subsequently grafted with DOPO, are currently available commercially, higher molecular weight polymer could also be used in the synthesis described below and may result in more durable coatings.

### Method of Making

The polymer of the present disclosure is made by contacting a polybutadiene polymer and DOPO in a solvent.

DOPO is a compound that is commercially available from manufacturers such as TCI America.

The polybutadiene polymer may be a homopolymer (i.e., made using just butadiene monomer) or a copolymer (i.e., made from butadiene and one or more different monomers). In the polymerization of the 1,3-butadiene monomer, a 1,2-addition results in olefinic side chains as in Formula (II), while a 1,4-addition results in a carbon-carbon double bond present along the polymer backbone such as in Formula (IV). The 1,4-addition is thermodynamically favored and generally has a high content within a polybutadiene homopolymer. However, the 1,2-addition reaction can be favored under particular polymerizing conditions (such as using a living anionic polymerization), resulting in a polybutadiene polymer having a predominate 1,2-vinyl structure. The polybutadiene polymer used to make the polymer of the present disclosure comprises predominately the 1,2-vinyl structure as shown in Formula (II). In one embodiment, the polybutadiene homopolymer comprises at least 60, 70, 75, 80, 85, 90, 95, or even 100% of the 1,2-vinyl structure with the balance being cis-1,4-polybutadiene and/or trans-1,4-polybutadiene. Such polybutadiene homopolymers are commercially available from companies such as Nippon Soda Co., Ltd., Tokyo, Japan under their B or G series and MilliporeSigma, Burlington, MA.

In some embodiments, the polybutadiene polymer is epoxidized comprising units according to Formula (II) and Formula (III). In one embodiment, the polybutadiene polymer comprises at least 10, 12, 14, or even 16 mole % of interpolymerized units according to Formula (III). In one embodiment, the polybutadiene polymer comprises at most 50, 45, 40, 35, 30, 25, or even 20 mole % of interpolymerized units according to Formula (III). Such polymers are known in the art (see for example, JP 2011137092 (Mori et al.)) and are commercially available from companies such as Nippon Soda under their JP series. As the epoxy group is generally not susceptible to reaction during the grafting of DOPO onto the polybutadiene polymer using the method as disclosed herein, these epoxy groups can be selectively used in subsequent reactions (such as curing or further chemical modification) of the DOPO-grafted polymer of the present disclosure.

In one embodiment, the polybutadiene polymer has a number average molecular weight of at least 500, 1000, or even 2000 grams/mole. In one embodiment, the polybutadiene polymer has a number average molecular weight of at most 50000, 25000, 20000, 10000, 5000, 4000, 3000, 2500, 2000, or even 1500 grams/mole. However, the molecular weight may vary based on the comonomers that are present.

By adjusting the number of moles of DOPO to the number of pendent 1,2-vinyl group in the polybutadiene polymer, the amount of grafting of DOPO onto the polymer can be controlled. In some embodiments, it may be desirable for all of the pendent 1,2-vinyl groups to be reacted with DOPO so an excess of DOPO may be used. While in other embodiments, it may be desirable for less than all of the pendent 1,2-vinyl groups to be reacted with DOPO so fewer moles of DOPO would be used. The amount of DOPO grafted onto the polybutadiene polymer may be dictated by how the polymer of the present disclosure is used. For example, balancing flexibility with flame-retardancy of the final product. In one embodiment, the mole ratio of DOPO to the pendent 1,2-vinyl group in the polybutadiene polymer is in the range 1 to 0.2, 1 to 0.5, or even 1 to 1. In one embodiment, the mole ratio of DOPO to the pendent 1,2-vinyl group in the polybutadiene polymer is in the range 1 to 1, 1 to 1.2, 1 to 1.5, 1 to 2, 1 to 3, 1 to 5, 1 to 10, 1 to 25, 1 to 50, 1 to 75, or even 1 to 100.

The DOPO and the polybutadiene polymer are contacted in a solvent. The solvent should be selected such that at least a portion of both the DOPO and the polybutadiene polymer are in solution so that they can undergo the grafting reaction. Exemplary solvents can include polar aprotic solvents such as tetrahydrofuran, acetone, acetonitrile, dichloromethane, ethyl acetate, cyclopentyl methyl ether, methyl-tert-butyl ether, dimethyl formamide, dimethylacetamide, N-methyl-2-pyrrolidone, sulfolane, nitriles (such as acetonitrile, adiponitrile, and benzonitrile), and dimethylsulfoxide. In another embodiment, the solvent is a nonpolar solvent, such as toluene, xylene, benzene, chloroform. In some embodiments, a mixture of solvents can be used.

A radical initiator is added to the reaction vessel comprising the dissolved DOPO and polybutadiene polymer to form a pre-reaction mixture. The pre-reaction mixture is then exposed to either thermal or photo radiation to activate the radical initiator, forming the DOPO-grafted polymer of the present disclosure.

Any radical initiator as known in the art may be used. In one embodiment, the radical initiator is a thermal initiator, wherein upon exposure to thermal radiation, the initiator forms a radical. Exemplary thermal initiators include: organic peroxides (such as dicumyl peroxide, benzoyl peroxide, lauryl peroxide, or benzoyl peroxide). In another embodiment, the radical initiator is a photoinitiator, wherein upon exposure to electromagnetic radiation, the initiator forms a radical. Exemplary photoinitiators include those commercially available under the trade designations “IRGACURE” (e.g., Irgacure 651) and “DAROCURE” (e.g., DAROCURE 1173) from BASF, Ludwigshafen, DE and “ESACURE” (e.g. ESACURE KB1) from Lamberti, Gallarate, IT.

The type of activation used to initiate the reaction of the polybutadiene polymer with DOPO will be dictated by the initiator selected, with thermal initiators activated by thermal radiation and photoinitiators activated by photo radiation. One advantage of using the above-mentioned reactions to graft DOPO onto the polybutadiene polymer is that it may be more cost effective due to the avoidance of catalysts, expensive solvents, and/or high temperatures. For example, the reactions of the present disclosure may be done at temperatures of less 120, 110, 100, 50, or even 30° C., or even done at room temperature.

The conditions for conducting the radical initiation are known in the art. Typically, at most 5, 3, or even 2 wt % and at least 1.5, 1, 0.5, or even 0.1 wt % of the radical initiator versus DODO is needed to generate the DOPO-grafted polymer of the present disclosure.

Advantageously, because of the reaction employed, it is not necessary to further purify the reaction product. Thus, in one embodiment, the reaction product comprises unreacted DOPO. However, the reaction product can be purified using techniques known in the art (e.g., recrystallization, column chromatography, sublimation, etc.).

### Composition Comprising Polymer

The DOPO-grafted polymer of the present disclosure can be used in a composition to cover a surface. The composition may be a liquid or a solid.

In one embodiment, the composition is a liquid comprising the DOPO-grafted polymer of the present disclosure and a solvent. Such solvents include those mentioned above. In one embodiment, the DOPO-grafted polymer is at a solids concentration of at least 1, 5, 10, 15, or even weight (wt) % in the liquid mixture. In one embodiment, the DOPO-grafted polymer is at a solids concentration of at most 80, 60, 50, 40, 30, or even 25 wt % in the liquid mixture.

The composition (either liquid or solid) may comprise additional additives to improve the processability and/or performance of the resulting product. Exemplary additives include: a processing aid, an auxiliary flame retardant, toughening agent, and antioxidant.

Exemplary processing aides include a surfactant or dispersant to help blend the polymer of the present disclosure with a different matrix or help with coating of the composition.

In one embodiment, an auxiliary flame retardant is added. The auxiliary flame retardant may be used control the cost of the final product and/or improve the physical properties of the final product such as writability, color, etc. Exemplary auxiliary flame retardants include: a bromine-based flame retardant, a phosphorus-based flame retardant, a phosphorus-nitrogen compound, intumescent flame retardant, or an inorganic flame retardant.

In one embodiment, an antioxidant is used to assist with the shelf life of the final product. Exemplary antioxidants can include those available under the trade designations IRGANOX 1010, IGRANOX 1098, and IRGAFOS 168, available from vendors such as MilliporeSigma.

In one embodiment, an auxiliary toughening agent may be added to improve the durability of the resulting composition. Exemplary toughening agents are ethylene-octene copolymer, maleic anhydride grafted ethylene-octene copolymer, glycidyl methacrylate grafted polyolefin thermoplastic elastomer, styrene-butadiene-styrene copolymer compound, maleic anhydride grafted styrene-butadiene-styrene copolymer, hydrogenated styrene-butadiene-styrene copolymer, maleic anhydride grafted hydrogenated styrene-butadiene-styrene copolymer, ethylene propylene rubber, maleic anhydride grafted ethylene propylene rubber, EPDM (ethylene, propylene, and diene copolymer) rubber, maleic anhydride grafted EPDM rubber, EPDM grafted glycidyl methacrylate, and thermoplastic polyurethane.

The amount of the components used in the composition can vary depending on what the components are and the desired performance properties. Generally, when the content of the auxiliary flame retardant is relatively large, the toughness of the composite material decreases, and when the content of auxiliary toughening agent is relatively large, the flame retardant performance of the composite material decreases. In one embodiment, the DOPO-grafted polymer is the primary matrix component in a composition. For example, the composition comprises at least 50, 60, 70, 80, or even 90% by solids weight (wt) of the polymer of the present disclosure. An exemplary composition could include the following the components DOPO-grafted polymer, 70-85 wt %; auxiliary flame retardant, 0-20 wt %; auxiliary toughening agent, 0-30 wt %; and antioxidant, 0.1-0.6 wt %. In another embodiment, the DOPO-grafted polymer is blended with different (or second) polymer matrix (e.g., (meth)acrylate, polyamide, etc.). In this scenario, the polymer of the present disclosure may be a minor component in the overall composition such as at least 1 or even 5% and at most 40, 30, 20, 15, or even 15% by weight solids. An exemplary composition could include the following components: DOPO-grafted polymer, 5-40 wt %; second polymer 60-85 wt %; auxiliary flame retardant, 0-30 wt %; auxiliary toughening agent, 0-30 wt %; and antioxidant, 0.1-2 wt %.

### Multilayered Article

The composition of the present disclosure comprising the DOPO-grafted polymer is applied to a substrate to form a multilayered article. In one embodiment, the composition is a liquid, and the composition is coated onto and/or imbibed into the substrate. The substrate may be immersed into the liquid composition, or the liquid composition may be coated onto the substrate using techniques as known in the art including dip coating, spray coating, forward and reverse roll coating, and die coating. Die coaters include knife coaters, slot coaters, slide coaters, fluid bearing coaters, slide curtain coaters, drop die curtain coaters, and extrusion coaters among others.

In another embodiment, the composition is a solid, for example a film, which is applied (e.g., laminated) onto the surface of a substrate.

The DOPO-grafted polymers of the present disclosure are useful as flame retardants. Thus, these polymers may be used to protect underlaying surfaces and/or substrates from flames. In one embodiment, the substrate is a flammable material. Such flammable materials include polyethylene terephthalate, or a polyolefin (such as polypropylene). In one embodiment, the substrate comprises fibers. In one embodiment, the substrate may be a fabric.

Typically, the exposed surface of the substate is continuously covered by a composition comprising the DOPO-grafted polymer to form a barrier between a flame and the substrate. In one embodiment, the composition comprising the DOPO-grafted polymer has an average thickness of at least 0.05, 0.1, 0.5, 1, 10, 50, 100, 200, 500, 800, 1000, or even 2000 micrometers (μm). In one embodiment, the composition comprising the polymer of the present disclosure has an average thickness of at most 100, 50, 25, 10, 5, 1, or even 0.5 millimeters.

In some embodiments, the composition of the present disclosure is applied to a substrate that is not rigid. Thus, the composition should have flexibility, such that the composition of the present disclosure moves with the underlaying substrate (e.g., fabric) and does not crack or peel, which can compromise the flame-retardant properties.

In one embodiment, the substrate comprising the DOPO-grafted polymer is flame retardant, meaning that when a substrate is coated or imbibed with the polymer of the present disclosure, the sample will meet certain flame and/or flammability criteria.

In one embodiment, the polymer of the present disclosure, when coated onto a substrate such as a fabric, passes Underwriter's Laboratory UL 94 Vertical Thin Material Flammability test. This test method evaluates the burning and afterglow times as well as dripping tendencies of a sample when exposed to a 20 mm flame height for two 3 second periods. Depending on whether or not the sample continued to burn or show an afterglow, drips, or combusts leads to a test rating with VTM-0 being the highest rating, followed by VTM-1 and VTM-2. In one embodiment, the polymer of the present disclosure when coated on and/or imbibed in a substrate has a rating of VTM-1 or even VTM-0 when tested according to UL 94 VTM test method, which is current at the time of filing this disclosure.

In one embodiment, the polymer of the present disclosure, when coated onto a substrate such as a fabric, passes NFPA 701 “Standard Methods of Fire Tests for Flame Propagation of Textiles and Films” 2019 edition. This test method evaluates the flammability of a sample when exposed to a flame for 12 s. Depending on the resulting flame, char length, and flaming residue after exposure, the sample is rated. In one embodiment, the polymer of the present disclosure, when coated on and/or imbibed in a substrate, passed the NFPA 701 certification.

Dripping is an observed phenomenon during fires and can promote fire spread. In one embodiment, the polymer of the present disclosure, does not drip when exposed to a flame.

### Examples

Unless otherwise noted, all parts, percentages, ratios, etc. in the Examples and the rest of the specification are by weight. Unless otherwise indicated, all other reagents were obtained, or are available from fine chemical vendors such as MilliporeSigma, (Burlington, MA) or may be synthesized by known methods. Table 1 (below) lists materials used in the examples and their sources.

TABLE 1
Materials List

| DESIGNATION | DESCRIPTION | SOURCE |
|---|---|---|
| B-3000 | Liquid 1,2-polybutadiene obtained under the | Nippon Soda (Tokyo, |
| | trade designation NISSO-PB B-3000. | Japan) |
| DOPO | 9,10-Dihydro-9-oxa-10-phosphaphenanthrene- | TCI America |
| | 10-oxide. | (Portland, OR, USA) |
| JP-200 | Liquid epoxidized 1,2-polybutadiene obtained | Nippon Soda |
| | under the trade designation NISSO-PB JP-200. | |
| OP930 | Organic phosphinate flame retardant obtained | Clariant (Munich, |
| | under the trade desingationEXOLIT OP 930. | Germany) |
| Fabric | A nonwoven fabric with an adhesive on one side | 3M Co., Maplewood, |
| | available under the trade designation 3M SELF | MN |
| | STICK LIQUID PROTECTION FABRIC | |
| SB36 | Flame retardant, aluminum trihydroxide obtained | JM Huber (Edison, |
| | under the trade designation HYMOD SB36 SG. | NJ, USA) |
| M916 | Flame retardant, aluminum trihydrate obtained | JM Huber (Edison, |
| | under the trade designation MICRAL 916 | NJ, USA) |
| THF | Tetrahydrofuran | MilliporeSigma, |
| | | Burlington, MA |
| VAZO-67 | Thermal radical initiator obtained under the trade | MilliporeSigma, |
| | designation VAZO-67 | |
| HA-8 | Water-based acrylic emulsion obtained under the | Dow (Midland, MI) |
| | trade designation RHOPLEX HA-8 | |

### Test Methods

### Flame Test 1

This flame test was used as a surrogate for UL 94 test. Samples were 6 inches long×2 inches wide (15.2 cm×5 cm) and hung vertically. The top of the flame from a Bunsen burner was applied to the bottom of the hung sample. The flame height of the Bunsen burner was 20 mm high. The flame was applied for 3 seconds(s) and then removed. If there was no flame on the sample after removal of the flame, the flame from the Bunsen burner was applied a second time for 3 s and removed. If the flame on the sample did not go out within 10 s upon removal of the Bunsen burner 10 flame or if the flame consumed the sample completely, the sample was said to not pass.

### Flame Test 2

This flame test was used as a surrogate for a NFPA 701 Test. The test was done as follows: The sample was tested in a vertical flame test chamber Model: 701S from Govmark (Farmingdale, NY, USA). The flame is adjusted to 1.5 inches (3.8 centimeters (cm)) high and the top of the flame was applied to the bottom of a 10 in long×3 in wide (25.4 cm×7.6 cm) sample. The flame is applied for 12 seconds to the bottom of the sample and removed. The samples were observed for dripping.

The fabric samples were deemed as passing FLAME TEST 2 if the following criteria were met: If after removal of the flame, a flame continued to appear on the fabric for less than 4.0 s (i.e., time to self extinguish); after the test is concluded, the fabric sample had lost no more than 6.0 inches (15.2 centimeters) of length.

### EXAMPLES

### Example 1 (EX-1): DOPO-Grafted Polybutadiene

In a 250-milliliter (mL) round-bottom flask, 12.36 grams (g) of B-3000, 37.64 g of DOPO, 0.75 g of VAZO-67 and 150 g of THF was placed. The flask was placed in a silicone oil bath and the mixture was stirred with a magnetic stirrer to make a homogenous solution. When a homogeneous mixture was obtained, the mixture was heated to 70° C. and was maintained at that temperature overnight with constant stirring. After completing the reaction, the mixture was cooled to room temperature. A slightly yellow transparent solution was obtained. NMR spectroscopy confirmed the desired chemical compound and no signal due to C≡C was observed, suggesting consumption of the C═C double bonds during the reaction.

### Example 2 (EX-2): DOPO-Grafted Epoxidized Polybutadiene

In a 250 mL round bottom flask, 13.97 g of JP-200, 36.03 g of DOPO, 0.72 g of VAZO67 and 150 g of THF was placed. The flask was placed in a silicone oil bath and the mixture was stirred with a magnetic stirrer to make a homogenous solution. When a homogeneous mixture was obtained, the mixture was heated to 70° C. and was maintained at the temperature overnight with constant stirring. After completing the reaction, the mixture was cooled to room temperature. A slightly yellow transparent solution was obtained. NMR spectroscopy confirmed the desired chemical compound and no signal due to C═C was observed, suggesting consumption of the C═C double bonds during the reaction.

### Example 3 (EX-3): Fabric Coated with DOPO-Grafted Polybutadiene

The fabric strip was placed on a counter with the nonwoven side facing up. The solution produced in EX-1 was lightly dripped onto the top of the fabric until the entire top of the fabric looked wet. The coated fabric was dried in an oven at 60° C. for 20 minutes. This coating procedure was thought to imbibe the coating into the nonwoven as the thickness of the fabric before and after coating did not nominally change.

### Example 4 (EX-4): Fabric Coated with DOPO-Grafted Epoxidized Polybutadiene

The fabric strip was placed on a counter with the nonwoven side facing up. The solution produced in EX-2 was lightly dripped onto the top of the fabric until the entire top of the fabric looked wet. The strip was dried in an oven at 60° C. for 20 minutes.

### Comparative Example 1 (CE-1): Fabric with No Coating

Fabric was provided and used as obtained.

### Comparative Example 2 (CE-2): Fabric Coated with OP930

OP930 was mixed with HA8. The final weight percent was 40% solids OP930 and 60% solids HA8. The resulting water-based solution was roll coated by hand onto the nonwoven side of a strip of fabric.

### Comparative Example 3 (CE-3): Fabric Coated with SB36

SB36 was mixed with HA8. The final weight percent was 60% solids SB36 and 40% solids HA8. The resulting mixture was roll coated by hand onto the nonwoven side of a strip of fabric.

### Testing of Fabric Samples

Fabric samples of CE-1, EX-3, and EX-4 were tested according to the FLAME TEST 1 Test Procedure described above. The results are as follows: CE-1 was fully consumed 23 s after first flame application. EX-3 and EX-4 had no burning and no dripping.

Fabric samples of CE-1, CE-2, CE-3, EX-3, and EX-4 were tested according to FLAME TEST 2. The results are shown in Table 2.

TABLE 2

| | | | Length of | |
|---|---|---|---|---|
| | | Time to self- | fabric | Drip |
| Sample | Description | extinguish (s) | burned (in) | observed |
| CE-1 | Fabric with no | 0 | 6.5 | no |
| | coating | | | |
| CE-2 | Fabric with OP930 | 0 | 6.375 | no |
| | Coating | | | |
| CE-3 | Fabric with SB36 | 0 | 6.125 | no |
| | Coating | | | |
| EX-3 | Fabric coated with | 0 | 4.25 | no |
| | DOPO-grafted | | | |
| | Polybutadiene | | | |
| EX-4 | Fabric coated with | 0 | 5 | no |
| | DOPO-grafted | | | |
| | epoxidized | | | |
| | polybutadiene | | | |

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A polymer comprising at least one interpolymerized monomeric unit according to formula I: 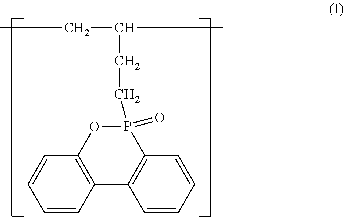
and
at least one interpolymerized monomeric unit according to formula III

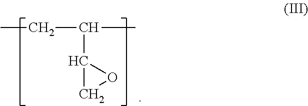

2. The polymer of claim 1 further comprising at least one interpolymerized monomeric unit according to formula II

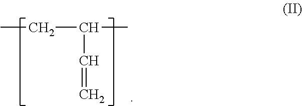

3. (canceled)

4. The polymer of claim 1, wherein the polymer has a molecular weight of at least 1500 grams per mole.

5. The polymer of claim 1, wherein the polymer is a random copolymer.

6. The polymer of claim 1, wherein the polymer comprises at least 0.1% and at most 12% by weight of phosphorous.

7. The polymer of claim 1, wherein at least 10% of the interpolymerized monomeric units in the polymer are according to Formula I.

8. The polymer of claim 1, wherein at least 50% of the interpolymerized monomeric units in the polymer are according to Formulas I and II.

9. The polymer of claim 1, wherein at least 5% and at most 45% of the interpolymerized monomeric units in the polymer are according to Formula III.

10. A composition comprising the polymer according to claim 1.

11. (canceled)

12. (canceled)

13. (canceled)

14. (canceled)

15. The composition according to claim 10, wherein the composition comprises at least 75% solids by weight of the polymer.

16. A multilayered article comprising a substrate and a layer thereon, wherein the layer comprises the polymer according to claim 1.

17. (canceled)

18. The multilayered article of claim 16, wherein an exposed surface of the substrate is continuously covered by the layer.

19. The multilayered article of claim 16, wherein the layer is imbedded in the substrate.

20. (canceled)

21. A method of making the polymer according claim 1, the method comprising:
contacting a polybutadiene polymer, and 9,10-dihydro-9-oxa-10-phosphaphenanthrene-10-oxide in a solvent to form a solution, wherein the polybutadiene polymer comprises at a plurality of pendent —CH═CH₂ groups;
contacting the solution with a radical initiator to form a pre-reaction mixture;
initiating the radical initiator to generate radicals in the pre-reaction mixture to form the polymer.

22. The method according to claim 21, wherein the polybutadiene polymer comprises a majority of interpolymerized units according to formula (II).

23. The method of claim 21, wherein the radical initiator is a thermal initiator.

24. The method according to claim 23, further comprising heating the pre-reaction mixture to a temperature above an activation temperature of the radical initiator.

25. The method according to claim 21, wherein the radical initiator is a photoinitiator.

26. The method according to claim 25, further comprising exposing the pre-reaction mixture to actinic radiation.

27. (canceled)

28. The method of claim 21, wherein the weight ratio of polybutadiene polymer to 9,10-dihydro-9-oxa-10-phosphaphenanthrene-10-oxide is 1:0.2 to 1:100.
